(19) United States
(12) Patent Application Publication
(10) Pub. No.: US 2013/0077166 A1
(43) Pub. Date: Mar. 28, 2013

(54) COLOR FILTER AND REFLECTIVE DISPLAY DEVICE EMPLOYING THE SAME

(71) Applicants: CHUNG-WEI WANG, Tu-Cheng (TW); CHIU-HSIUNG LIN, Tu-Cheng (TW)

(72) Inventors: CHUNG-WEI WANG, Tu-Cheng (TW); CHIU-HSIUNG LIN, Tu-Cheng (TW)

(73) Assignee: HON HAI PRECISION INDUSTRY CO., LTD., Tu-Cheng (TW)

(21) Appl. No.: 13/491,553

(22) Filed: Jun. 7, 2012

(30) Foreign Application Priority Data
Sep. 28, 2011 (TW) 100135108

(51) Int. Cl. G02B 5/30

(52) U.S. Cl. 359/491.01

(57) ABSTRACT

A color filter includes a transparent substrate including a plurality of pixel areas, each of the pixel areas includes a plurality of filter areas and at least one transparent area. And a plurality of filter units are formed on the respective filter areas, the transparent area of the transparent substrate is free of filter units formed thereon. The ambient light that passes through the transparent area twice are not filtered. Finally, the light entering to user's eyes include red light filtered by the red sub-pixel unit, the green sub-pixel unit and the blue sub-pixel unit, and light doesn't be filtered. The brightness of light entering to user's eyes is enhanced.

### BACKGROUND

1. Technical Field

The present disclosure relates to color filters, especially to a color filter capable of improving the brightness of reflective display devices using the color filter.

2. Description of Related Art

Reflective display devices, such as electrophoretic display devices, have attributes of good brightness and contrast, wide viewing angles, state bistability, and low power consumption, as compared with liquid crystal displays. The electrophoretic display devices are capable of displaying colorful images by using a color filter.

A color filter formed by a conventional method is shown in FIG. 8. In the conventional method, a black matrix 10 is first formed on a glass substrate (not shown) to define a plurality of sub-pixels 20 including a red sub-pixel 201, a green sub-pixel 202 and a blue sub-pixel 203. An inkjet printing process is then performed to inject a color ink (red, green, or blue) to fill the sub-pixels 20. A thermal baking process may be then performed to solidify the color ink forming a corresponding filter unit. Take the red sub-pixel regions 201 for example, ambient light passing through the red sub-pixel regions 201 are reflected by an electrophoretic display layer (not shown), the reflected light pass through the red sub-pixel regions 201 again and travels to user's eyes. Because the ambient light needs to pass through the red sub-pixel regions 201 twice, light transmittance ability of the color filter is decreased, and display devices using the color filter is affected.

Therefore, what is needed is a color filter alleviating the limitations described above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a cross-sectional view of a color filter in accordance with a first exemplary embodiment.

FIG. 2 is a schematic view of the color filter according to the first embodiment of FIG. 1.

FIG. 3 is a cross-sectional view of the light paths of a reflective display layer having the color filter according to the first embodiment of FIG. 1.

FIG. 4 is a schematic view of the color filter according to a second embodiment.

FIG. 5 is a schematic view of the color filter according to a third embodiment.

FIG. 6 is a schematic view of the color filter according to a fourth embodiment.

FIG. 7 is a schematic view of the color filter according to a fifth embodiment.

FIG. 8 is a schematic view of a conventional color filter.

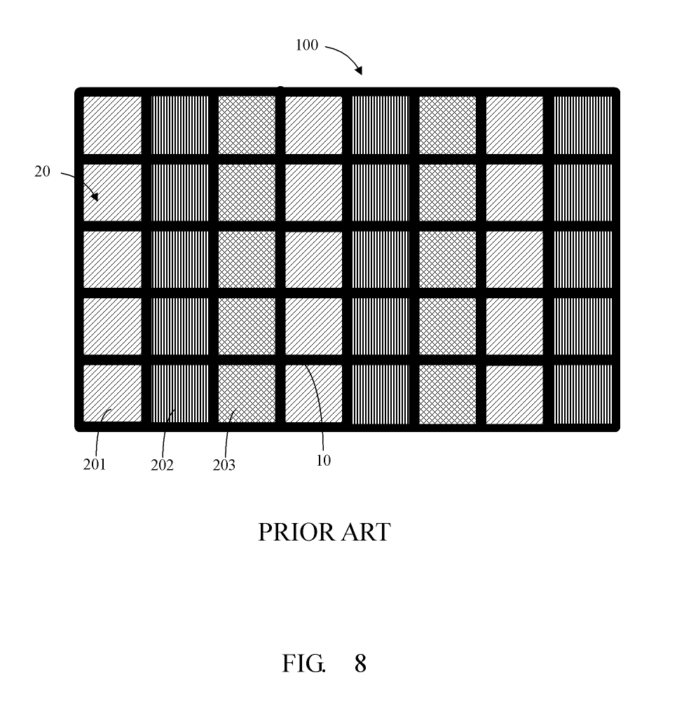

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

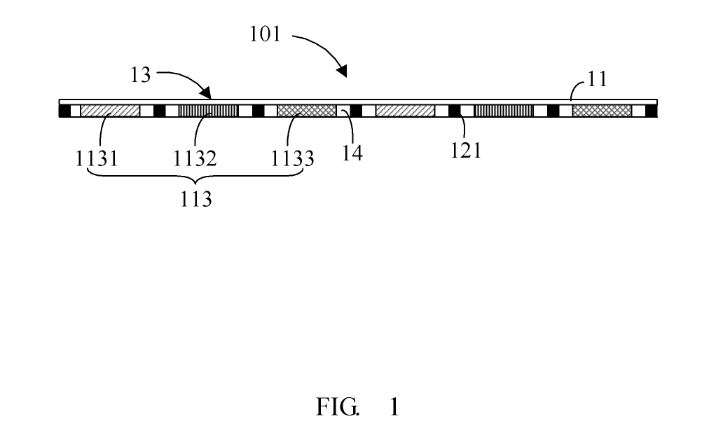

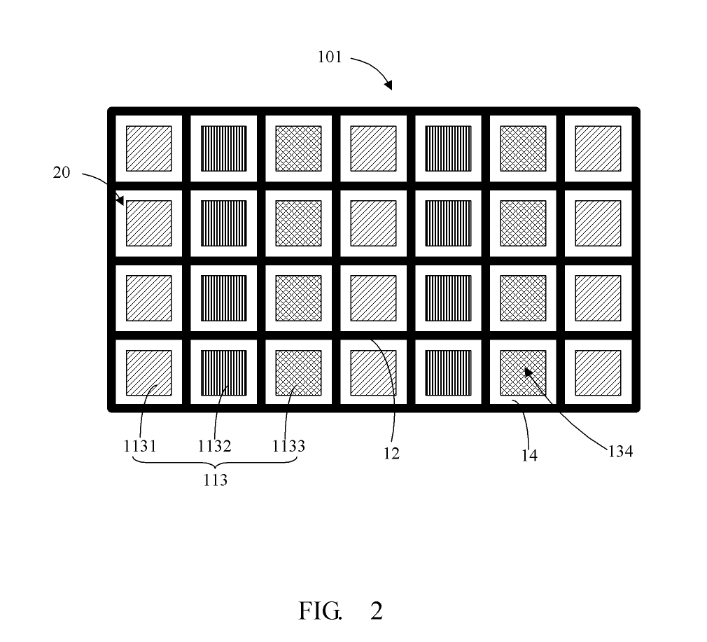

Referring to FIGS. 1 and 2, a color filter 101 is illustrated according to a first embodiment. The color filter 101 includes a transparent substrate 11, and a number of pixel areas 13 are defined on the transparent substrate 11. Each of the pixel areas 13 includes a number of filter areas 134 and at least one transparent area 14, in this embodiment, a plurality of filter units 113 formed on the respective filter areas 134, the transparent area 14 of the transparent substrate 11 being free of filter units 113 formed thereon. The filter units 113 include a red sub-pixel unit 1131, a green sub-pixel unit 1132 and a blue sub-pixel unit 1133.

In the first embodiment, the color filter 101 further includes a black-matrix 12 formed on a surface of the transparent substrate 11. The black-matrix 12 includes a number of partition walls 121 with a number of sub-pixels 20 therein, the partition walls 121 cooperatively define the transparent substrate 11 to the number of sub-pixels 20. An inkjet printing process can be performed to inject color ink to the sub-pixels 20 forming the filter units 113 including the red sub-pixel unit 1131, the green sub-pixel unit 1132, and the blue sub-pixel unit 1133. In the first embodiment, at least one transparent area 14 of each pixel area includes a number of transparent areas 14 each surrounding a corresponding filter area 134. Namely, in each pixel area 13, the red sub-pixel unit 1131, the green sub-pixel unit 1132, and the blue sub-pixel unit 1133 are respectively surrounded by the transparent areas 14.

The transparent substrate 11 can be made of flexible plastic with high transmissivity, such as polyimide (PI), polycarbonate (PC), polyethylene terephthalate (PET) or polymethylmethacrylate (PMMA). In the first embodiment, the transparent substrate 11 is made of PET. The transparent substrate 11 also can be made of glass or other rigid material with high transmissivity.

The black-matrix 12 is formed on one side of the transparent substrate 11, and the material constituting the black-matrix 12 is, for example, epoxy resin, or some other materials with good light-shielding property and low reflectivity. According to this embodiment, the method to form the black-matrix 12 includes forming a photo-sensitive resin layer (not shown) on the transparent substrate 11 by spin coating. The photo-sensitive resin layer is patterned by using the conventional photolithography to form the partition walls 121 of black-matrix 12. The partition walls 121 of the black-matrix 12 can effectively separate different colors of the light passing through each sub-pixel 20, such that the purity of the color displayed by each sub-pixel units can be increased because the affecting from adjacent sub-pixel units are minimized/eliminated.

In the first embodiment, the transparent areas 14 are exposed with a plurality of recesses formed thereon and bounded by the corresponding filter units 113. In this embodiment, after injecting color ink to the sub-pixels 20, a chemistry etching, or projection photolithography can be employed to form the recesses surrounding the corresponding filter units 13. In other embodiments, a transparent material is formed over the transparent areas 14, such as, the transparent area 14 can be a groove filled with transparent material, like transparent resin, transparent plastic. The transparent area 14 accounts for about 2% to about 95% of the area of each pixel area 13. In this embodiment, it accounts for about 5% to about 15%.

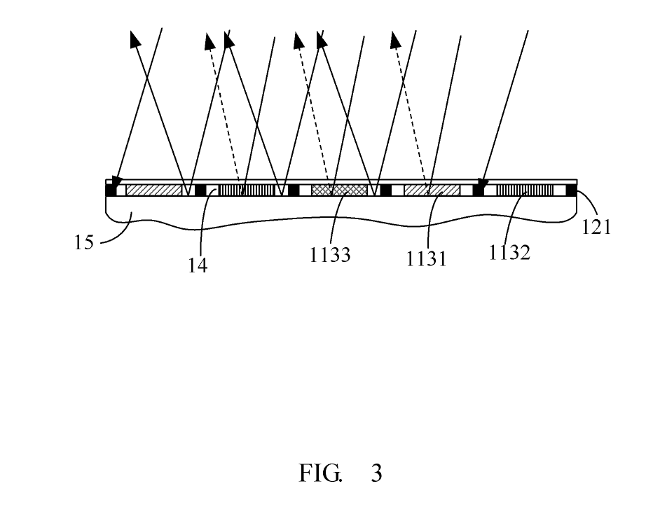

Referring to FIG. 3, a cross-sectional view of the light paths of a reflective display layer 15 having the color filter 101 is shown according to the first embodiment. The reflective display layer 15 can be an electrophoretic display layer, an electrowetting display layer or other black-white reflective display layer. Ambient light passes through the color filter 101 including the red, green, blue sub-pixel units 1131, 1132, 1133 and the transparent areas 14, then reaches to the surface of the reflective display layer 15 and are partly or fully reflected back by the reflective display layer 15. The reflected light passes through the color filter 101 again and travels to user's eyes.

Take the red sub-pixel unit 1131 for example, ambient light passes through the red sub-pixel unit 1131 and the transparent areas 14, and then is reflected back by the reflective display layer 15. The ambient light passing through the red sub-pixel unit 1131 is filtered and only red light can pass through the red sub-pixel unit 1131. The ambient light can directly pass through the transparent area 14. A portion of the reflected light passes through the red sub-pixel unit 1131 again and finally travels to user's eyes, and the remaining of the reflected light passes through the transparent area 14 and travels to user's eyes. The ambient light that passing through the transparent area 14 twice is not filtered, and includes multi-color light. Finally, the light traveling to user's eyes includes red light filtered by the red sub-pixel unit 1131, and light directly passing through the transparent areas 14. The brightness of light traveling to user's eyes is enhanced.

In other embodiments, the transparent area 14 can be defined as any suitable shapes and positioned at other locations in each of the pixel 13 according to need.

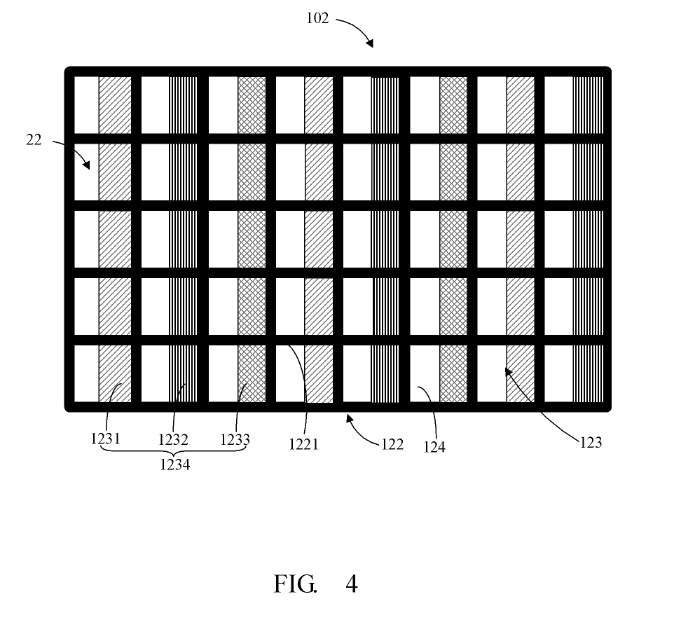

Referring to FIG. 4, a color filter 102 is illustrated according to a second embodiment. The color filter 102 is similar to color filter 101 described in the first embodiment. The color filter 102 includes a transparent substrate (not shown), and a number of pixel areas 123 are defined on the transparent substrate. A black-matrix 122 is formed on the transparent substrate and includes a number of partition walls 1221 with a number of sub-pixels 22 therein. Each of the pixel areas 123 includes a number of filter areas 1234 and at least one transparent area 124, in this embodiment, each of the filter areas 1234 includes a red sub-pixel unit 1231, a green sub-pixel unit 1232 and a blue sub-pixel unit 1233 defined in a sub-pixel 22 respectively. The difference between the color filter 102 and 101 is that a transparent area 124 is separated from the corresponding filter area by the partition walls 1221 in each sub-pixels 22. In the second embodiment, the transparent area 124 is a groove filled with transparent material.

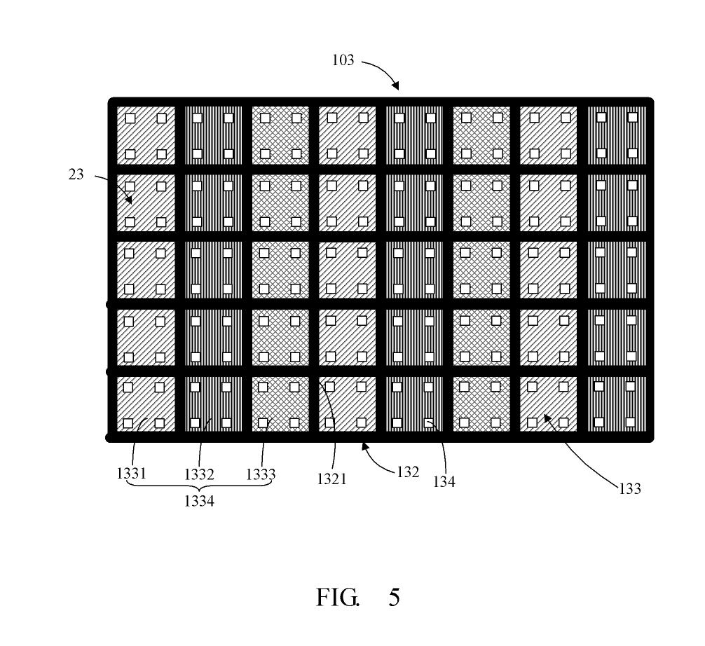

Referring to FIG. 5, a color filter 103 is illustrated according to a third embodiment. The color filter 103 is similar to color filter 101 described in the first embodiment. The color filter 103 includes a transparent substrate (not shown), and a number of pixel areas 133 are defined on the transparent substrate. A black-matrix 132 is formed on the transparent substrate and includes a number of partition walls 1321 with a number of sub-pixels 23 therein. Each of the pixel areas 133 includes a number of filter areas 1334 and at least one transparent area 134, in this embodiment, each of the filter areas 1334 includes a red sub-pixel unit 1331, a green sub-pixel unit 1332 and a blue sub-pixel unit 1333 defined in a sub-pixel 23 respectively. The difference between the color filters 103 and 101 is that a number of discrete transparent areas 134 are located within each of filter areas 1334. In the third embodiment, the discrete transparent areas 134 are a number of small recesses formed in the red sub-pixel unit 1331, the green sub-pixel unit 1332 and the blue sub-pixel unit 1333.

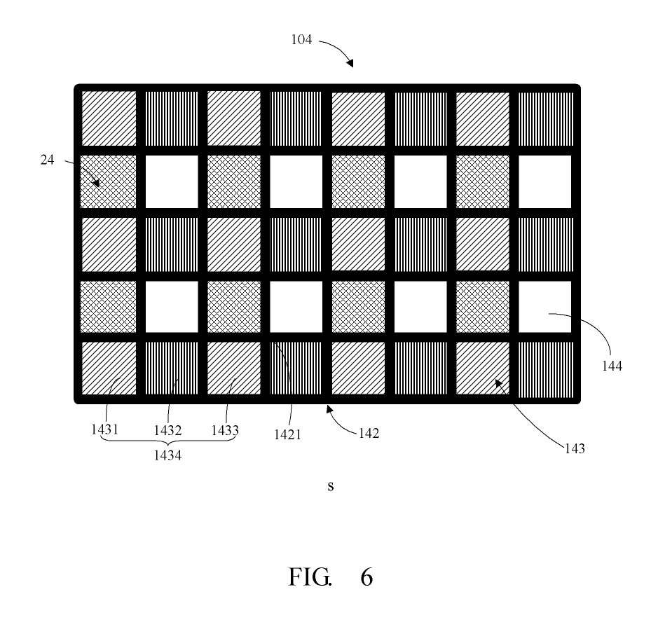

Referring to FIG. 6, a color filter 104 is illustrated according to a fourth embodiment. The color filter 104 is similar to color filter 101 described in the first embodiment. The color filter 104 includes a transparent substrate (not shown), and a number of pixel areas 143 are defined on the transparent substrate. A black-matrix 142 is formed on the transparent substrate and includes a number of partition walls 1421 with a number of sub-pixels 24 therein. Each of the pixel areas 143 includes a number of filter areas 1434 and at least one transparent area 144, in this embodiment, each of the filter areas 1434 includes a red sub-pixel unit 1431, a green sub-pixel unit 1432 and a blue sub-pixel unit 1433 defined in a sub-pixel 24 respectively. The difference between the color filter 104 and 101 is that the at least one transparent area 144 of each pixel area 143 is separated from the filter areas 1434 by the corresponding partition walls 1421 in each pixel area 143. Namely, each pixel area 143 includes an individual transparent areas 144 defined in a sub-pixel 24 separated from the red sub-pixel unit 1431, the green sub-pixel unit 1432 and the blue sub-pixel unit 1433.

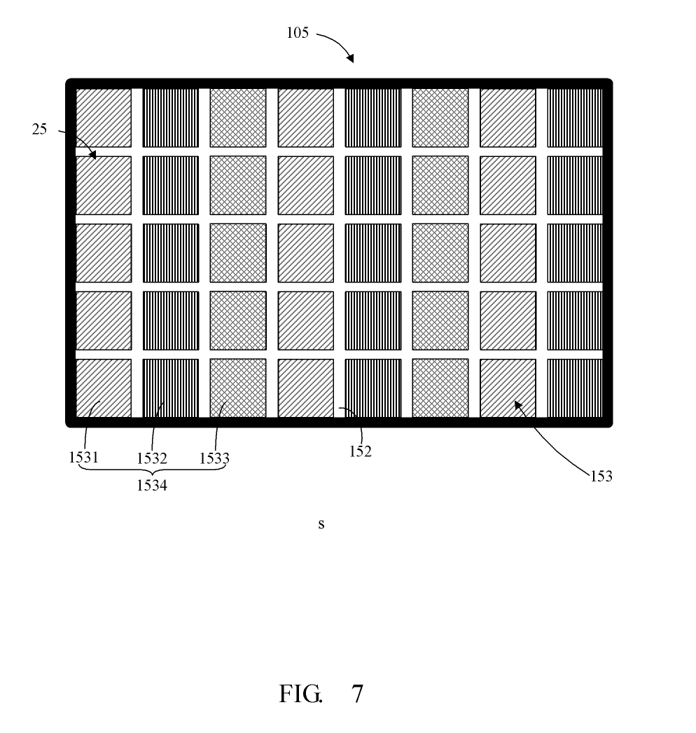

Referring to FIG. 7, a color filter 105 is illustrated according to a fifth embodiment. The color filter 105 is similar to color filter 101 described in the first embodiment. The color filter 105 includes a transparent substrate (not shown), and a number of pixel areas 153 are defined on the transparent substrate. The difference between the color filter 105 and 101 is that it is a transparent-matrix 152 with grid-shaped that divides the transparent substrate to a number of sub-pixels 25, rather than the black-matrix. Each of the pixel areas 153 includes a number of filter areas 1534 and at least one transparent area, in this embodiment, each of the filter areas 1534 includes a red sub-pixel unit 1531, a green sub-pixel unit 1532 and a blue sub-pixel unit 1533 defined in a sub-pixel 25 respectively. Namely, in this embodiment, the at least one transparent area is grid-shaped and spaces the filter areas from each other. In this embodiment, the transparent-matrix 152 is composed of a transparent material and is formed on the transparent substrate. An inkjet printing process can be performed to inject color ink to the sub-pixels 25 to form the red sub-pixel unit 1531, the green sub-pixel unit 1532, and the blue sub-pixel unit 1533. In this embodiment, the transparent-matrix 152 acts as the transparent area to allow ambient light passing through without being filtered.

It is to be understood, however, that even though numerous characteristics and advantages of the present disclosure have been set forth in the foregoing description, together with details of the structure and function of the present disclosure, the present disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A color filter comprising:
a transparent substrate, the substrate including a plurality of pixel areas, each of the pixel areas comprising a plurality of filter areas and at least one transparent area; and
a plurality of filter units formed on the respective filter areas, the transparent area of the transparent substrate being free of filter units formed thereon.

2. The color filter of claim 1, wherein the transparent areas are exposed with a plurality of recesses formed thereon and bounded by the corresponding neighboring filter units.

3. The color filter of claim 1, wherein a transparent material is formed over the transparent areas.

4. The color filter of claim 1, further comprising a black-matrix formed on the transparent substrate, wherein each of the pixel areas comprises a plurality of sub-pixels, the black-matrix comprising a plurality of partition walls with the sub-pixels therein, the filter areas are defined in the respective sub-pixels.

5. The color filter of claim 4, wherein the at least one transparent area of each pixel area comprises a plurality of transparent areas each surrounding a corresponding filter area in each sub-pixels.

6. The color filter of claim 4, wherein the at least one transparent area of each pixel area is separated from the corresponding filter area by the partition walls in each sub-pixels.

7. The color filter of claim 4, wherein the at least one transparent area of each pixel area is separated from the filter areas by the corresponding partition walls in each pixel area.

8. The color filter of claim 7, wherein the at least one transparent area and the filter areas of each pixel area are of substantially the same shape.

9. The color filter of claim 1, wherein the at least one transparent area of each pixel area comprises a plurality of discrete transparent areas located within each of filter areas.

10. The color filter of claim 1, wherein the at least one transparent area is grid-shaped and spaces the filter areas from each other.

11. The color filter of claim 1, wherein the transparent substrate is made of a material selected from the group consisting of polyimide, polycarbonate, polyethylene terephthalate, polymethylmethacrylate, and glass.

12. The color filter of claim 1, wherein the at least one transparent area accounts for in area two percent to ninety five percent of the pixel area.

13. A reflective display device comprising:
a reflective display layer and a color filter arranged on a surface of the reflective display layer, and the color filter comprising
a transparent substrate, the substrate including a plurality of pixel areas, each of the pixel areas comprising a plurality of filter areas and at least one transparent area; and
a plurality of filter units formed on the respective filter areas, the transparent area of the transparent substrate being free of filter units formed thereon.

14. The reflective display device of claim 13, wherein the transparent areas are exposed with a plurality of recesses formed thereon and bounded by the corresponding filter units.

15. The reflective display device of claim 13, wherein a transparent material is formed over the transparent areas.

16. The reflective display device of claim 13, wherein comprising a black-matrix formed on the transparent substrate, the black-matrix comprising a plurality of partition walls with a plurality of sub-pixels therein, the plurality of filter areas are defined in the respective sub-pixels.

17. The reflective display device of claim 16, wherein the at least one transparent area of each pixel area comprises a plurality of transparent areas each surrounding a corresponding filter area in each sub-pixels.

18. The reflective display device of claim 16, wherein the at least one transparent area of each pixel area is separated from the corresponding filter area by the partition walls in each sub-pixels.

19. The reflective display device of claim 16, wherein the at least one transparent area of each pixel area is separated from the filter areas by the corresponding partition walls in each pixel area.

20. The reflective display device of claim 13, wherein the at least one transparent area of each pixel area comprises a plurality of discrete transparent areas located within each of filter areas.
